(19) United States
(12) Patent Application Publication
(10) Pub. No.: US 2013/0048682 A1
(43) Pub. Date: Feb. 28, 2013

(54) COCKTAIL MAKER FOR MAKING RAINBOW COCKTAILS

(71) Applicant: Bo LIN, Chengdu (CN)

(72) Inventor: Bo LIN, Chengdu (CN)

(21) Appl. No.: 13/662,601

(22) Filed: Oct. 29, 2012

Related U.S. Application Data
(63) Continuation-in-part of application No. PCT/CN2011/073240, filed on Apr. 25, 2011.

(30) Foreign Application Priority Data
Apr. 29, 2010 (CN) 201010158378.6

(51) Int. Cl. B67D 7/06

(52) U.S. Cl. 222/504

(57) ABSTRACT

A cocktail maker for preparing rainbow cocktails, including: a stand; a liquor outlet head including an inner cavity and a side wall including a plurality of outlet holes; a measuring cup; a motor disposed on the stand; and a transmission device. The liquor outlet head is cylindrical and is vertically disposed on the stand. The outlet holes are connected with the inner cavity, and the inner cavity is connected with the measuring cup. The liquor outlet head is driven by the motor to rotate via the transmission device.

### CROSS-REFERENCE TO RELATED APPLICATIONS

This application is a continuation-in-part of International Patent Application No. PCT/CN2011/073240 with an international filing date of Apr. 25, 2011, designating the United States, now pending, and further claims priority benefits to Chinese Patent Application No. 201010158378.6 filed Apr. 29, 2010. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a cocktail maker, and more particularly to a cocktail maker for preparing rainbow cocktails.

2. Description of the Related Art

Rainbow cocktails, which present different stratified colors, are very difficult to prepare. To prepare a rainbow cocktail, base liquors and beverages having different specific gravities are added to a goblet in turn. A typical method for preparing a rainbow cocktail is to lean a bar spoon against the inner wall of a goblet, and allow the liquor to flow down along the bar spoon and into the goblet slowly. However, in actual preparation, only those liquors having much different specific gravities can be stratified; most classical rainbow cocktail formulas cannot be well stratified and only two or three layers can be presented, because different layers are apt to mix with each other. In addition, the goblet body cannot be deep so that the bar spoon can be close to the liquor level. Thus, manual preparation is very difficult and time consuming Usually, an ordinary bartender cannot prepare a rainbow cocktail having more than five layers, especially when using a goblet having a deep body.

### SUMMARY OF THE INVENTION

In view of the above-described problems, it is one objective of the invention to provide a cocktail maker for more easily preparing rainbow cocktails. The maker sprays different liquors evenly along the side wall of the goblet taking advantage of centrifugal force to achieve a good stratification effect. The cocktail maker for preparing rainbow cocktails is simple in structure, and quick and convenient in operation.

To achieve the above objective, in accordance with one embodiment of the invention, there is provided a cocktail maker for preparing rainbow cocktails comprising: a stand; a liquor outlet head comprising an inner cavity and a side wall comprising a plurality of outlet holes; a measuring cup; a motor disposed on the stand; and a transmission device. The liquor outlet head is cylindrical and vertically disposed on the stand. The outlet holes are connected with the inner cavity, and the inner cavity is connected with the measuring cup. The liquor outlet head is driven by the motor to rotate via the transmission device.

In a class of this embodiment, a connection device is disposed between the liquor outlet head and the stand for adjusting a distance between the liquor outlet head and the stand.

In a class of this embodiment, an opening valve is disposed between the measuring cup and the inner cavity.

In a class of this embodiment, a rotational speed of the liquor outlet head is 300-1500 rpm.

In a class of this embodiment, the outlet holes are no less than 3 in number, and are disposed along a circumferential direction of the side wall of the liquor outlet head with equal intervals between each other.

In a class of this embodiment, the stand comprises a lifting support for adjusting a height of the stand.

In a class of this embodiment, the measuring cup comprises a plurality of plates. The plates divide the measuring cup into several independent compartments. Each compartment comprises a bottom, and the bottom is provided with a through hole to connect with the inner cavity.

In a class of this embodiment, the stand further comprises a battery box for accommodating batteries to drive the motor.

Advantages of the cocktail maker for preparing rainbow cocktails are summarized below.

By means of the principle of centrifugal force, the cocktail maker for preparing rainbow cocktails adds liquors into a goblet automatically rather than manually. Thus, the prepared rainbow cocktails not only have a good stratification effect, but also have many layers, which cannot be realized by the manual preparation. Furthermore, the maker of the invention has high efficiency that the preparing time for each cocktail of the invention is much less than that prepared by a manual preparation. Finally, the maker is driven by batteries, and thus has a small size and light weight. Thus, it is convenient to prepare cocktails on guests' tables, thereby avoiding the shake in the delivery which will otherwise affect the stratification effect.

### BRIEF DESCRIPTION OF THE DRAWINGS

The invention is described hereinbelow with reference to the accompanying drawings, in which

FIG. 1 is a schematic diagram of a cocktail maker for preparing rainbow cocktails in accordance with one embodiment of the invention;

FIG. 2 is a schematic diagram of a liquor outlet head of a cocktail maker for preparing rainbow cocktails of FIG. 1;

FIG. 3 is a top view of a measuring cup of a cocktail maker for preparing rainbow cocktails;

FIG. 4 is a schematic diagram of a cocktail maker for preparing rainbow cocktails of FIG. 1 during use;

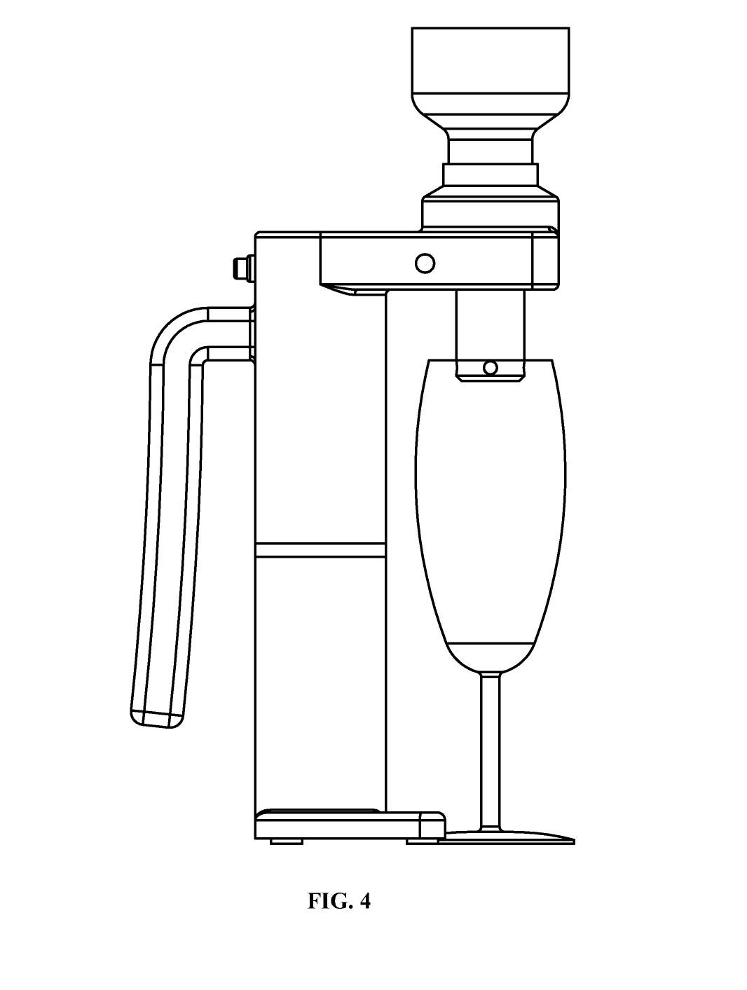

FIG. 5 is a schematic diagram of a cocktail maker for preparing rainbow cocktails in accordance with another embodiment of the invention; and

FIG. 6 is a schematic diagram of a liquor outlet head of a cocktail maker for preparing rainbow cocktails of FIG. 5.

### DETAILED DESCRIPTION OF THE EMBODIMENTS

To further illustrate the invention, experiments detailing a cocktail maker for preparing rainbow cocktails are described below. It should be noted that the following examples are intended to describe and not to limit the invention.

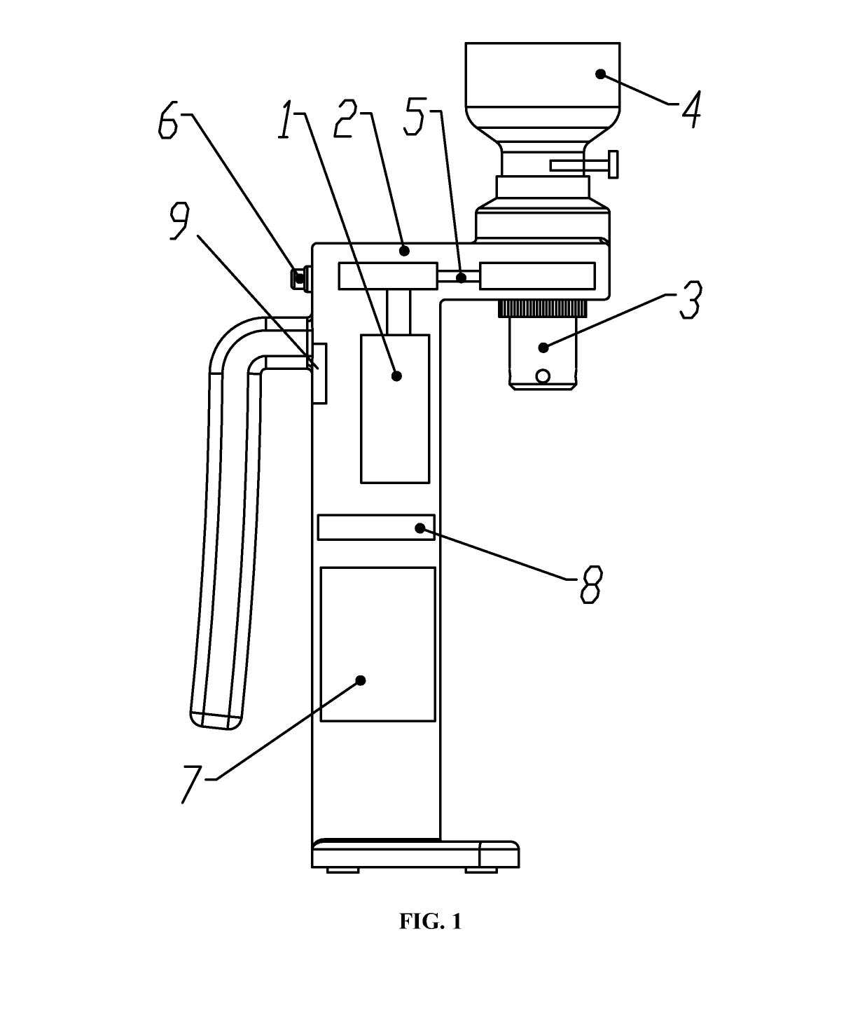

As shown in FIG. 1, a cocktail maker for preparing rainbow cocktails comprises: a stand, a motor 1 disposed on the stand, a transmission device 2, a speed controller 5, a liquor outlet head 3, a measuring cup 4, a switch 6, a lifting support 8, and batteries 7 for driving the motor 1. The liquor outlet head 3 is a hollow column vertically disposed on the stand. The liquor outlet head 3 comprises an inner cavity and a side wall comprising a plurality of outlet holes.

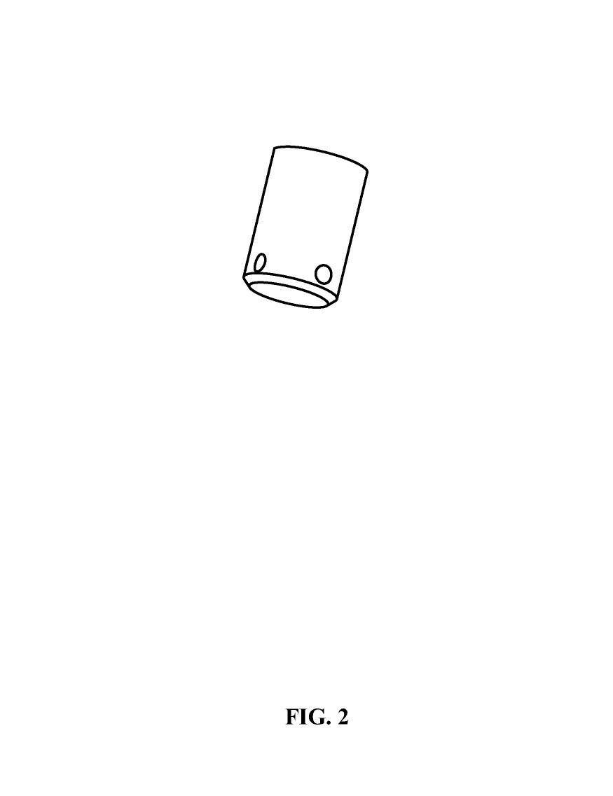

As shown in FIG. 2, the outlet holes are connected with the inner cavity, and the inner cavity is connected with the measuring cup 4.

The liquor outlet head 3 is driven by the motor 1 to rotate via the transmission device 2 and the speed controller 5. The motor 1 is controlled by the switch 2. The lifting support 8 is used to adjust the height of the stand in accordance with the height of the goblet.

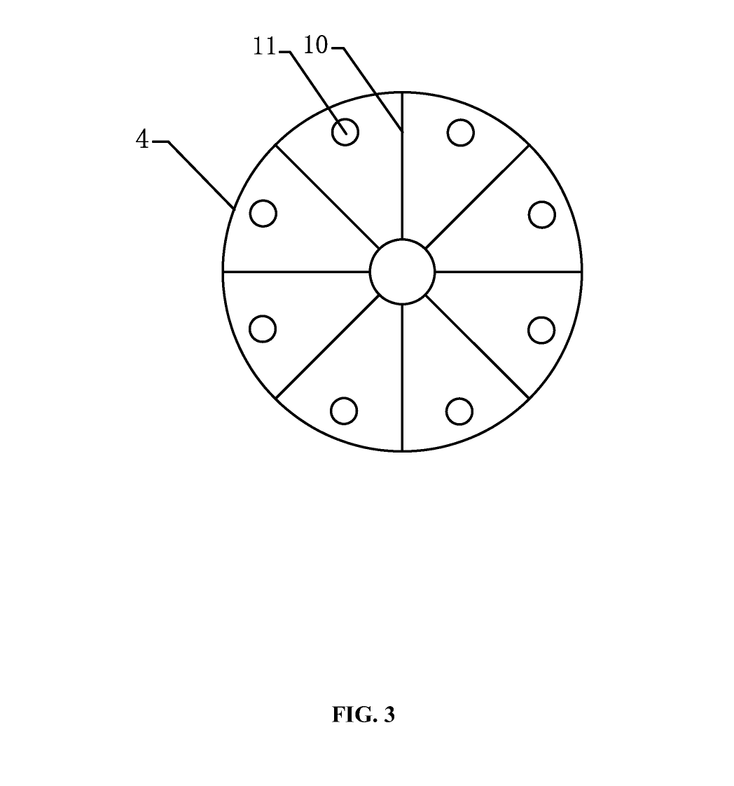

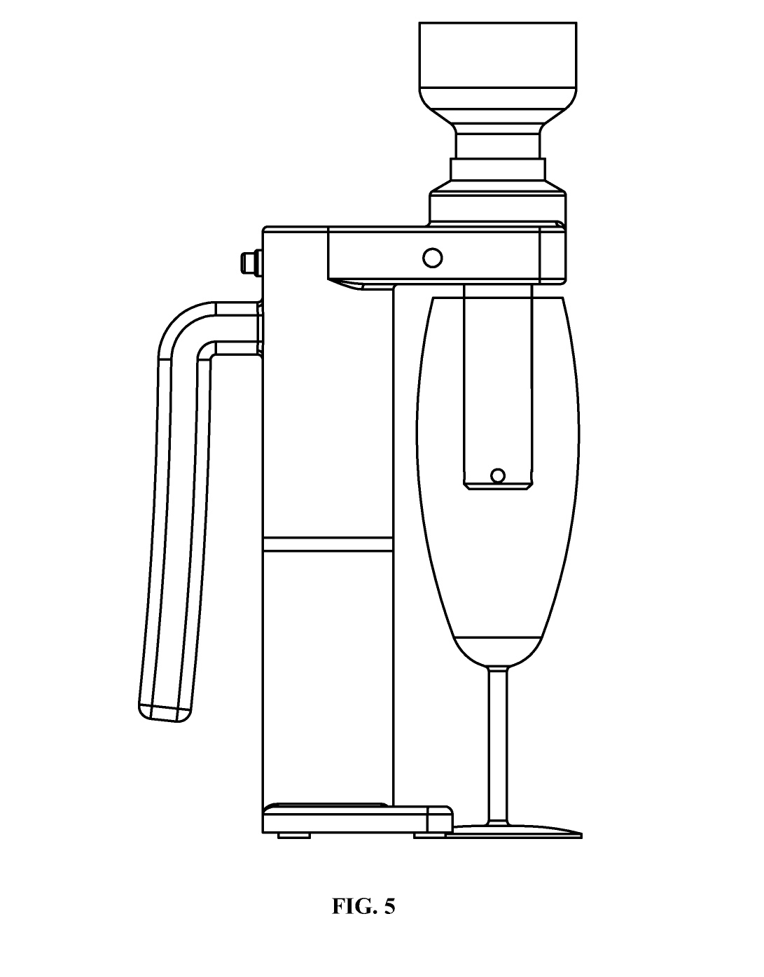

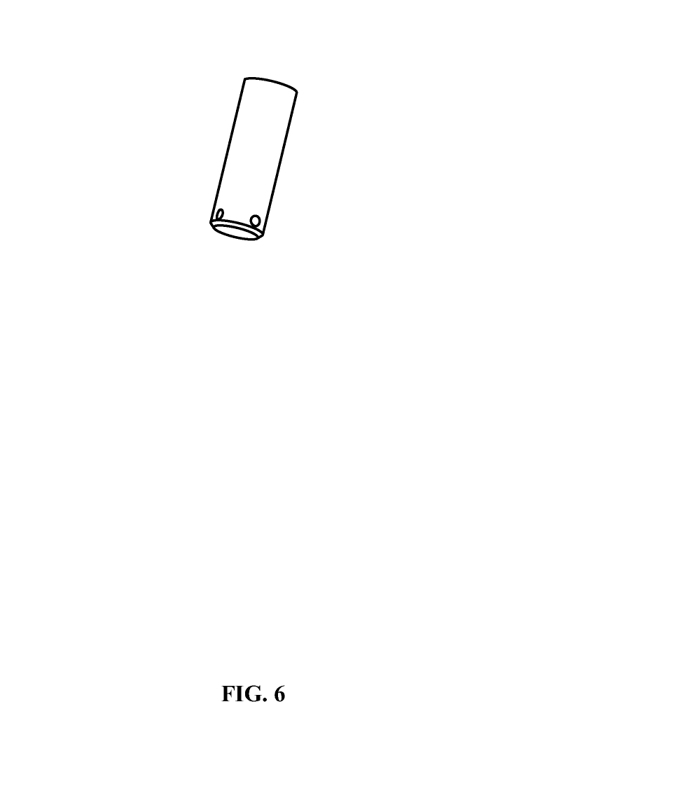

As shown in FIG. 3, the measuring cup 4 comprises eight plates 10 which divide the measuring cup 4 into eight independent compartments with the same size. Each compartment comprises a bottom, and the bottom is provided with a through hole 11 to connect with the inner cavity. By rotating the measuring cup, each compartment can be connected with the liquor outlet head. Thus, in the preparation for a cocktail, liquors for different layers are added into the corresponding compartments, rotating the measuring cup to connect each compartment with the liquor outlet head in order. To acquire a better effect, it is important to control the distance between the liquor outlet head 3 and the liquor level and the distance the liquor sliding along the wall of the goblet, thus, a regulating knob 9 can be arranged between the liquor outlet head 3 and the stand to adjust the distance between the liquor outlet head 3 and the stand, that is, the distance between the liquor outlet head 3 and the goblet base, as shown in FIG. 5. The liquor outlet head 3 matched with the regulating knob 9 is shown in FIG. 6 and provide with threads or racks matched with a connection device which are driven by the regulating knob 9 to adjust the distance between the liquor outlet head 3 and the stand, that is, the distance between the liquor outlet head 3 and the goblet. The rotational speed of the liquor outlet head 3 is 300-1500 rpm. The transmission device 2 employs a gear drive, belt drive, or the like.

The maker above is also provided with an areometer to measure the specific gravity of different liquors and to determine the order for adding the liquors into the goblet.

An opening valve can be arranged between the measuring cup and the inner cavity for controlling the speed of the liquors running out of the measuring cup.

During use, the areometer is used to measure the specific gravity of the liquor, and liquors are added into the goblet in order according to the specific gravity. As shown in FIG. 3, a slender goblet is used. First of all, liquor having a large specific gravity is added into the goblet directly, the maker of the invention is disposed above the goblet, and the lifting support 8 and the regulating knob 9 are adjusted to extend the liquor outlet head 3 into the goblet. Then, required volumes of liquors are added into the measuring cup 4. Turn on the switch 6 to make the liquor head rotate; after pressing the opening valve, the liquor is sprayed on the wall of the goblet evenly and runs down along the wall into the goblet due to the centrifugal force produced during the rotation of the liquor head. Thus, a new layer is formed. Then, release the opening valve and adjust the regulating knob 9 to raise the height of the liquor outlet head for leaving some space for the next layer of liquor. Liquor for the next layer is then added and the next layer is formed by repeating the above steps. The maker of the invention can prepare rainbow cocktails having many layers of different color conveniently with high efficiency, and each layer has clear margin which cannot be achieved by manual preparation methods.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A cocktail maker for preparing rainbow cocktails, comprising:
a) a stand;
b) a liquor outlet head comprising an inner cavity and a side wall comprising a plurality of outlet holes;
c) a measuring cup;
d) a motor disposed on the stand; and
e) a transmission device; wherein
the liquor outlet head is cylindrical and vertically disposed on the stand;
the outlet holes are connected with the inner cavity, and the inner cavity is connected with the measuring cup; and
the liquor outlet head is driven by the motor to rotate via the transmission device.

2. The cocktail maker of claim 1, wherein a connection device is disposed between the liquor outlet head and the stand for adjusting a distance between the liquor outlet head and the stand.

3. The cocktail maker of claim 1, wherein an opening valve is disposed between the measuring cup and the inner cavity.

4. The cocktail maker of claim 2, wherein an opening valve is disposed between the measuring cup and the inner cavity.

5. The cocktail maker of claim 1, wherein a rotational speed of the liquor outlet head is 300-1500 rpm.

6. The cocktail maker of claim 2, wherein a rotational speed of the liquor outlet head is 300-1500 rpm.

7. The cocktail maker of claim 1, wherein the outlet holes are no less than 3 in number, and are disposed along a circumferential direction of the side wall of the liquor outlet head with equal intervals between each other.

8. The cocktail maker of claim 2, wherein the outlet holes are no less than 3 in number, and are disposed along a circumferential direction of the side wall of the liquor outlet head with equal intervals between each other.

9. The cocktail maker of claim 1, wherein the stand comprises a lifting support for adjusting a height of the stand.

10. The cocktail maker of claim 2, wherein the stand comprises a lifting support for adjusting a height of the stand.

11. The cocktail maker of claim 1, wherein
the measuring cup comprises a plurality of plates;
the plates divide the measuring cup into several independent compartments; and
each compartment comprises a bottom, and the bottom is provided with a through hole to connect with the inner cavity.

12. The cocktail maker of claim 2, wherein
the measuring cup comprises a plurality of plates;
the plates divide the measuring cup into several independent compartments; and
each compartment comprises a bottom, and the bottom is provided with a through hole to connect with the inner cavity.

13. The cocktail maker of claim 1, wherein the stand further comprises a battery box for accommodating batteries to drive the motor.
